(19) United States
(12) Patent Application Publication
(10) Pub. No.: US 2016/0133997 A1
(43) Pub. Date: May 12, 2016

(54) BATTERY ASSEMBLY WITH ARRAY FRAME AND INTEGRATED HEAT EXCHANGER

(71) Applicant: FORD GLOBAL TECHNOLOGIES, LLC, Dearborn, MI (US)

(72) Inventors: Dhanunjay VEJALLA, Novi, MI (US); Adam DENLINGER, Saline, MI (US); Thomas ADLER, Northville, MI (US); Patrick Daniel Maguire, Ann Arbor, MI (US)

(21) Appl. No.: 14/536,966

(22) Filed: Nov. 10, 2014

(51) Int. Cl. H01M 10/615; H01M 2/10

(52) U.S. Cl. CPC H01M 10/615; H01M 10/6551; H01M 10/653; H01M 2/1083; H01M 10/625; H01M 2/1077; H01M 2220/20

(57) ABSTRACT

A battery assembly according to an exemplary aspect of the present disclosure includes, among other things, an array frame including a frame body and a slot formed through the frame body. A heat exchanger is received within the slot.

### TECHNICAL FIELD

This disclosure relates to a battery assembly for an electrified vehicle. The battery assembly includes a battery array and an integrated heat exchanger. The battery assembly may include various retention features for retaining the heat exchanger relative to the battery array.

### BACKGROUND

The need to reduce automotive fuel consumption and emissions is well known. Therefore, vehicles are being developed that either reduce or completely eliminate reliance on internal combustion engines. Electrified vehicles are one type of vehicle being developed for this purpose. In general, electrified vehicles differ from conventional motor vehicles in that they are selectively driven by one or more battery powered electric machines. Conventional motor vehicles, by contrast, rely exclusively on the internal combustion engine to drive the vehicle.

A high voltage battery assembly for powering electric machines of an electrified vehicle typically includes multiple battery arrays. Each battery array includes a plurality of battery cells and a support structure that generally surrounds the battery cells to build the battery array. A heat exchanger, such as a cold plate, may be positioned beneath the battery cells to thermally manage heat generated by the battery cells. Typically, the heat exchanger is clamped between the battery array and a tray to ensure robust contact between the heat exchanger and the battery cells.

### SUMMARY

A battery assembly according to an exemplary aspect of the present disclosure includes, among other things, an array frame including a frame body and a slot formed through the frame body. A heat exchanger is received within the slot.

In a further non-limiting embodiment of the foregoing assembly, the frame body extends along a longitudinal axis and includes a top portion, a bottom portion and frame arms that extend between the top portion and the bottom portion.

In a further non-limiting embodiment of either of the foregoing assemblies, the top portion includes a first side and a second side that each include an alternating pattern of rigid snap arms and flexible snaps arms.

In a further non-limiting embodiment of any of the foregoing assemblies, the slot is formed in the bottom portion of the frame body.

In a further non-limiting embodiment of any of the foregoing assemblies, a thermal fin extends within the frame body. The thermal fin includes a body and a leg that extends to a position outside of the frame body.

In a further non-limiting embodiment of any of the foregoing assemblies, the heat exchanger is biased against the leg of the thermal fin.

In a further non-limiting embodiment of any of the foregoing assemblies, the frame body includes a bottom portion including a top wall and a bottom wall that extend between opposing ends, the slot extending horizontally between the opposing ends and vertically between the top wall and the bottom wall.

In a further non-limiting embodiment of any of the foregoing assemblies, a spring feature protrudes upwardly from the bottom wall.

In a further non-limiting embodiment of any of the foregoing assemblies, the spring feature is angled relative to the bottom wall.

In a further non-limiting embodiment of any of the foregoing assemblies, the spring feature is corrugated.

A battery assembly according to another exemplary aspect of the present disclosure includes, among other things, an array frame including at least one retention arm and a heat exchanger connected to the array frame by the at least one retention arm.

In a further non-limiting embodiment of the foregoing assembly, the array frame houses a battery cell, and comprising a thermal interface material between the battery cell and the heat exchanger.

In a further non-limiting embodiment of either of the foregoing assemblies, the array frame includes an open bottom that establishes a pocket bound by side walls and a top wall. The at least one retention arm protrudes from at least one of the side walls and the top wall.

In a further non-limiting embodiment of any of the foregoing assemblies, the array frame is mounted to a tray.

In a further non-limiting embodiment of any of the foregoing assemblies, an air gap is between the heat exchanger and the tray.

A battery assembly according to another exemplary aspect of the present disclosure includes, among other things, a battery array including a plurality of array frames, a lower cover connected to at least a portion of the plurality of array frames, and a heat exchanger secured between the battery array and the lower cover.

In a further non-limiting embodiment of the foregoing assembly, a thermal interface material is between the heat exchanger and the plurality of array frames.

In a further non-limiting embodiment of either of the foregoing assemblies, one of the portion of the plurality of array frames and the lower cover includes a rigid retention arm and the other of the portion of the plurality of array frames and the lower cover includes a flexible retention arm that engages the rigid retention arm to secure the lower cover to the portion of the plurality of array frames.

In a further non-limiting embodiment of any of the foregoing assemblies, the flexible retention arm includes an extension that overlaps a second extension of the rigid retention arm.

In a further non-limiting embodiment of any of the foregoing assemblies, the battery array is mounted to a tray.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIGS. 2A and 2B illustrate an array frame of a battery array.

FIG. 3 illustrates a battery array built from stacked array frames.

FIG. 4 illustrates a retention feature of an array frame.

FIGS. 5A and 5B illustrate a spring feature of an array frame.

FIG. 5C is a blown-up view of encircled area AR1 of FIG. 5A.

FIGS. 5D and 5E illustrate additional exemplary spring features of an array frame.

FIG. 6 illustrates a battery assembly according to a first embodiment of this disclosure.

FIG. 7 illustrates a cross-sectional view of a battery assembly.

FIG. 8 schematically illustrates positioning of a heat exchanger relative to a plurality of array frames of a battery assembly.

FIG. 9 illustrates a battery assembly according to another embodiment of this disclosure.

FIG. 10 illustrates a cross-sectional view of a battery assembly.

FIG. 11 illustrates a battery assembly according to yet another embodiment of this disclosure.

### DETAILED DESCRIPTION

This disclosure describes exemplary battery assemblies that may be employed within electrified vehicles. The battery assemblies include one or more array frames that may be stacked and connected together to build a battery array. A heat exchanger is connectable to the battery array to thermally manage the heat generated by the battery cells of the battery array and also heat the battery cells during low environmental temperatures. The battery assembly may employ various retention features to secure the heat exchanger relative to the battery array. For example, in one embodiment, the array frames of the battery array include slots that establish a channel for receiving the heat exchanger beneath the battery cells. In another embodiment, the array frames include flexible retention arms for securing the heat exchanger to the battery array. In yet another embodiment, a lower cover connects to the array frames to secure the heat exchanger to the battery array. These and other features are discussed in greater detail in the paragraphs that follow.

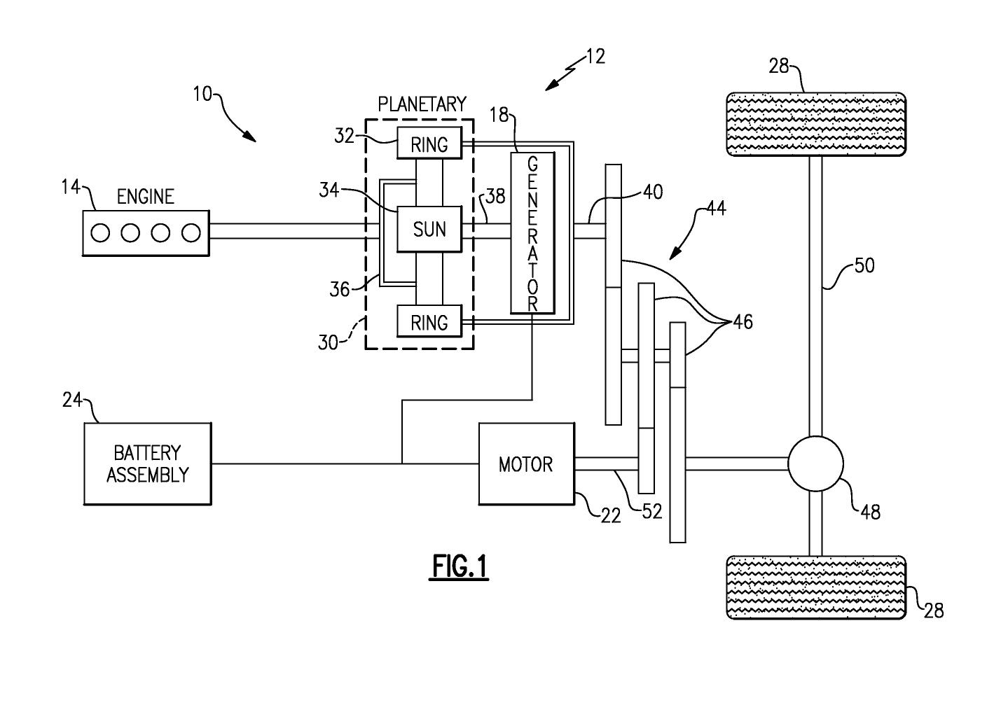

FIG. 1 schematically illustrates a powertrain 10 for an electrified vehicle 12. Although depicted as a HEV, it should be understood that the concepts described herein are not limited to HEV's and could extend to other electrified vehicles, including, but not limited to, plug-in hybrid electric vehicles (PHEV's) and battery electric vehicles (BEV's).

In one embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery assembly 24. In this example, the second drive system is considered an electric drive system of the powertrain 10. The first and second drive systems generate torque to drive one or more sets of vehicle drive wheels 28 of the electrified vehicle 12.

The engine 14, such as an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery assembly 24.

The battery assembly 24 is an example type of electrified vehicle battery assembly. The battery assembly 24 may include a high voltage battery pack that includes a plurality of battery arrays capable of outputting electrical power to operate the motor 22 and the generator 18. Other types of energy storage devices and/or output devices can also be used to electrically power the electrified vehicle 12.

In one non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery assembly 24 state of charge up to its maximum allowable discharging rate under certain driving patterns/cycles. The EV mode is an example of a charge depleting mode of operation for the electrified vehicle 12. During EV mode, the state of charge of the battery assembly 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally be operated in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery assembly 24 at a constant or approximately constant level by increasing the engine 14 propulsion usage. The electrified vehicle 12 may be operated in other operating modes in addition to the EV and HEV modes within the scope of this disclosure.

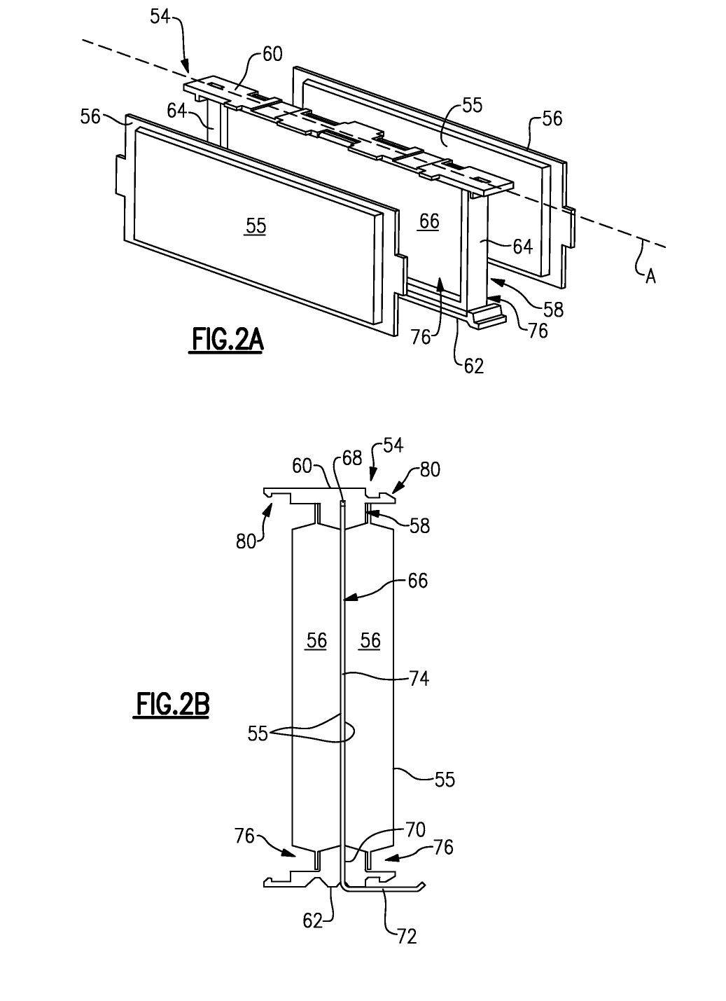

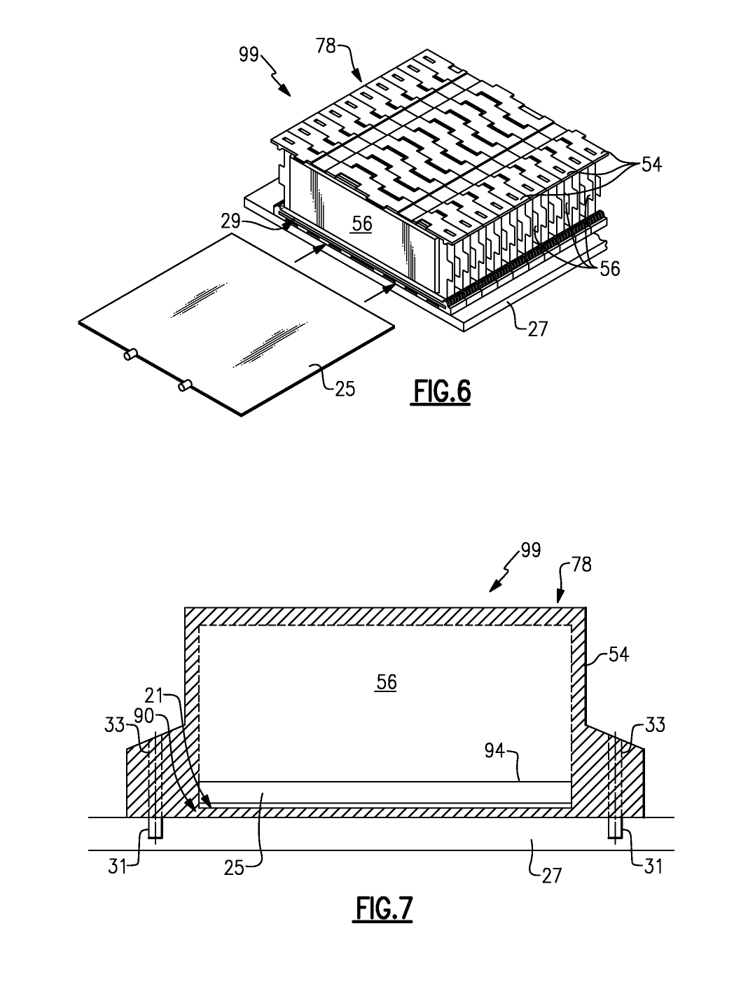

FIGS. 2A and 2B illustrate an array frame 54 that houses at least two battery cells 56. A plurality of array frames 54 may be stacked side-by-side to build a battery array (see, e.g., battery array 78 of FIGS. 3 and 6). One or more battery arrays that include multiple array frames 54 and battery cells 56 can be assembled and mounted inside a battery assembly, such as the battery assembly 24 of the electrified vehicle 12 of FIG. 1, to electrically power an electrified vehicle.

In one embodiment, the battery cells 56 are pouch cells for a high voltage battery assembly. One non-limiting example of a suitable pouch battery cell is a lithium-ion polymer battery. However, other types of battery cells are also contemplated, and it should be understood that this disclosure is not limited to pouch type battery cells.

The array frame 54 includes a frame body 58 that extends along a longitudinal axis A (see FIG. 2A). The frame body 58 includes a top portion 60, a bottom portion 62 and frame arms 64 that connect between the top portion 60 and the bottom portion 62. In one embodiment, the top portion 60 and the bottom portion 62 extend in parallel with the longitudinal axis A, and the frame arms 64 are transverse to the longitudinal axis A. In another embodiment, the frame body 58 is a unitary, plastic structure.

In one non-limiting embodiment, a thermal fin 66 may be at least partially embedded within the frame body 58 and extend between the top portion 60 and the bottom portion 62. In one embodiment, the thermal fin 66 is an aluminum thermal fin. However, other materials are additionally contemplated. The thermal fin 66 separates the battery cells 56 and may contact side faces 55 of the battery cells 56. During certain conditions, the thermal fin 66 removes heat from the battery cells 56. In other conditions, the thermal fin 66 may add heat to the battery cells 56. The frame body 58 establishes pockets 76 on both sides of the thermal fin 66. The battery cells 56 may be received within the pockets 76 to house the battery cells 56 within the array frame 54.

The thermal fin 66 may include a body 74 and a leg 72 that extends from the body 74 (see FIG. 2B). The body 74 may be embedded or molded into the frame body 58, while the leg 72 extends outside of the frame body 58. In another embodiment, the thermal fin 66 may be inserted into the frame body 58 such that one end of the body 74 is located within a groove 68 formed in the top portion 60 of the frame body 58, and an opposite end of the body 74 may extend through a passage 70 formed through the bottom portion 62 of the frame body 58. The leg 72 of the thermal fin 66 may be oriented transversely to the body 74 so it extends underneath the bottom portion 62 to the position outside of the frame body 58. In one embodiment, the leg 72 extends to a position that is beyond the side face 55 of the battery cell 56 housed substantially above the leg 72.

The frame body 58 may further include a plurality of retention features 80 that are integrated into the top portion 60. The bottom portion 62 could similarly include integrated retention features, although not shown in this embodiment. The retention features 80 may engage corresponding retention features of adjacent array frames 54 to build a battery array. In yet another embodiment, the frame arms 64 could include retention features similar to the retention features 80 for connecting adjacent array frames 54.

Referring to FIG. 3, a plurality of array frames 54 may be stacked side-by-side to construct a battery array 78. Two array frames 54 are depicted in FIG. 3, which omits the battery cells for clarity. This disclosure is not limited to any specific number of array frames 54 and/or battery cells 56 and is not intended to be limited to the specific configurations that are illustrated by the various Figures.

In one embodiment, the top portion 60 of the frame body 58 of each array frame 54 is rotationally symmetric about a vertical axis V that is transverse to the longitudinal axis A. In another embodiment, the bottom portion 62 is rotationally symmetric about the vertical axis V. In yet another embodiment, both the top portion 60 and the bottom portion 62 are rotationally symmetric about the vertical axis V. In this way, the array frames 54 can be provided in a repeating fashion to construct the battery array 78. The symmetry of the top portion 60 and/or the bottom portion 62 permits the use of common array end plates, thereby reducing cost and complexity of the battery array 78. In other words, unique left hand and right hand array end plates are not required to construct the battery array 78.

The top portion 60 of the frame body 58 includes a first side 84 and a second side 86 that both extend between opposing ends 96, 98. The first side 84 and the second side 86 both include a plurality of retention features 80 for connecting the array frame 54 to an adjacent array frame 54. In one embodiment, the retention features 80 protrude from both the first side 84 and the second side 86 of the top portion 60. In another embodiment, the top portion 60 of each array frame 54 is substantially flat.

In another non-limiting embodiment, the retention features 80 of the top portion 60 include a plurality of rigid snap arms 82A and a plurality of flexible snap arms 82B oriented in an alternating pattern along each of the first side 84 and the second side 86 of the top portion 60. Because the top portion 60 is rotationally symmetric about the vertical axis V, each flexible snap arm 82B of the first and second sides 84, 86 are aligned directly across the top portion 60 from a rigid snap arm 82A on the opposite side 84, 86. Thus, the array frames 54 provide a repeating design that simplifies assembly and reduces complexity of the battery array 78.

The rigid snap arms 82A and the flexible snap arms 82B of both the first side 84 and the second side 86 are oriented to engage corresponding features of an adjacent array frame 54 to connect the array frames 54 together. For example, the flexible snap arms 82B may be received over top of the rigid snap arms 82A to connect adjacent array frames 54. The flexible snap arms 82B may flex slightly as the rigid snap arms 82A are pushed toward the flexible snap arms 82B.

The top portion 60 of each array frame 54 may additionally include one or more recessed grooves 92. In one embodiment, each recessed groove 92 extends between the first side 84 and the second side 86 of the top portion 60 and is disposed between a rigid snap arm 82A and a flexible snap arm 82B on the first side 84 and the second side 86. The recessed grooves 92 of adjacent array frames 54 align with one another and can accommodate tension straps that bind the battery array 78 in a lengthwise direction to maintain a consistent array length and resist bulging of the battery cells 56 during certain conditions.

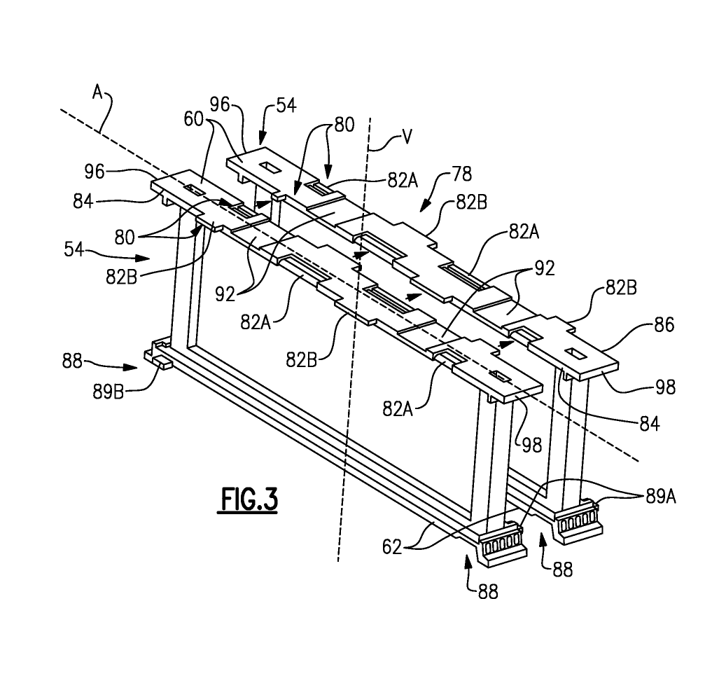

FIG. 4 illustrates features associated with the bottom portion 62 of an array frame 54. The bottom portion 62 may include a top wall 88 and a bottom wall 90 that extend between opposing ends 89, 91. Each of the opposing ends 89, 91 includes a foot 93. Additional feet 95 may protrude from the bottom wall 90 between the feet 93. The feet 93, 95 provide a substantially flat surface for positioning the array frame 54 on a supporting surface, such as a tray (see, for example, tray 27 of FIGS. 6-7).

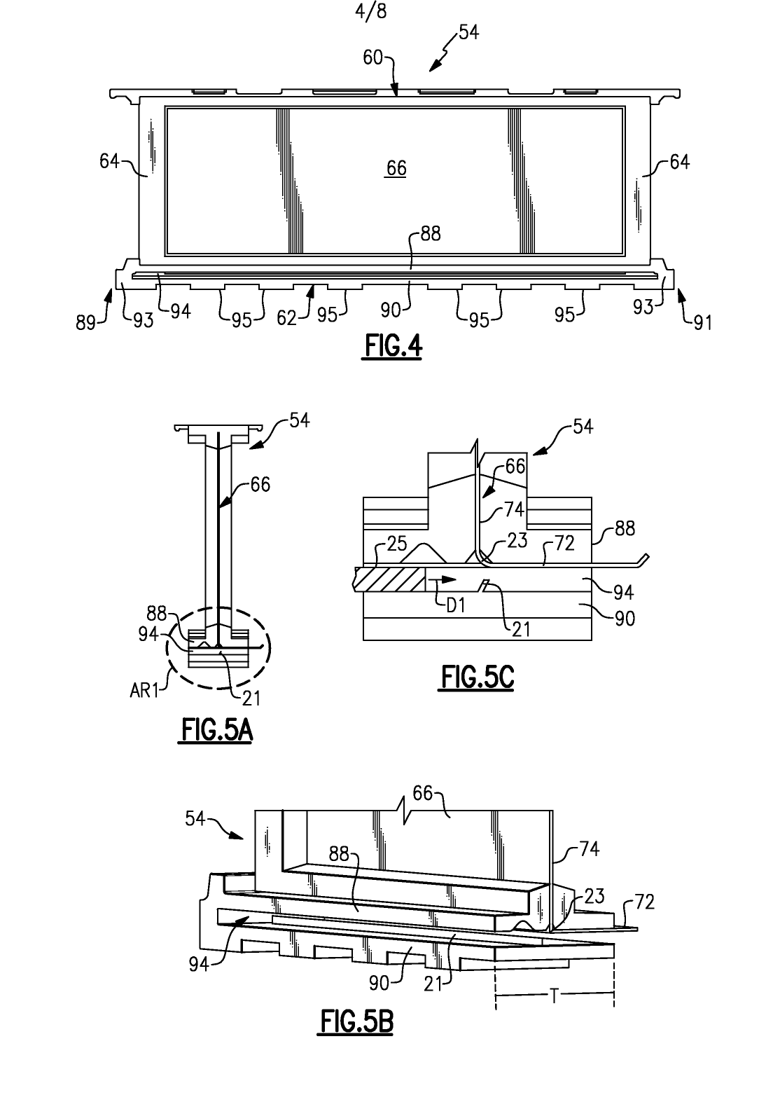

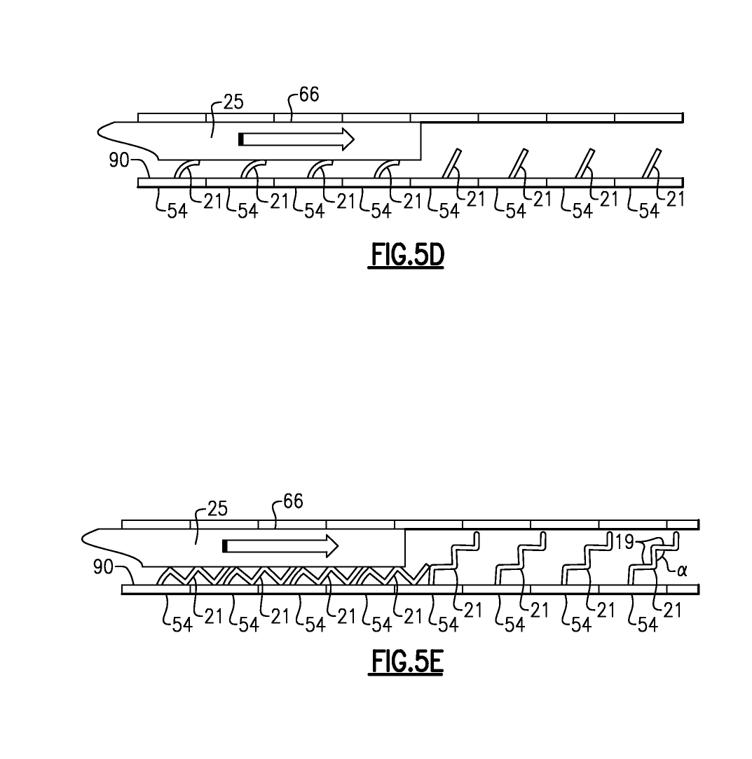

In one embodiment, a slot 94 extends through the bottom portion 62 of the array frame 54. In other words, the slot 94 is an opening that extends across a thickness T of the array frame 54 (see FIG. 5B). The slot 94 may extend horizontally between the opposing ends 89, 91 and vertically between the top wall 88 and the bottom wall 90, in one embodiment. The slot 94 is configured to receive a heat exchanger, as is further discussed below (see, for example, heat exchanger 25 of FIGS. 6-8). In one non-limiting embodiment, the slot 94 is molded into the array frame 54.

Referring to FIGS. 5A, 5B and 5C, the bottom wall 90 of the array frame 54 may include one or more spring features 21. In one embodiment, the spring feature 21 protrudes upwardly from the bottom wall 90 and may be angled relative to the bottom wall 90. The spring feature 21 may extend across an entire length or only portions of the length of the slot 94, and may be configured as a continuous piece or multiple spaced apart pieces. The spring feature 21 may be a plastic, flexible member that flexes in response to contacting a heat exchanger 25 that is inserted into the slot 94 in a slot insertion direction D1 (see FIG. 5C). The spring feature 21 is designed to maintain robust contact between the heat exchanger 25 and the thermal fin 66 of the array frame 54. Additional details concerning the relationship between the spring feature 21, the heat exchanger 25 and the thermal fin 66 are discussed in greater detail below.

In another embodiment, the spring feature 21 is positioned within the slot 94 such that it is aligned beneath a bend 23 of the thermal fin 66 (see FIGS. 5B and 5C). The bend 23 is a curved portion of the thermal fin 66 located between the body 74 and the leg 72. However, in other embodiments, the spring feature 21 could be positioned beneath any portion of the leg 72 of the thermal fin 66.

Referring to FIG. 5D, the bottom wall 90 of each array frame 54 may include a spring feature 21. The spring features 21 deflect upon insertion of a heat exchanger 25 to apply an upwards force against the heat exchanger 25 and facilitate improved contact between the heat exchanger 25 and the thermal fin 66. In another embodiment, shown in FIG. 5E, the spring features 21 may be corrugated to increase the upward force against the heat exchanger 25. An angle a between platforms 19 of the corrugated spring features 21 may be greater than or equal to 90 degrees.

FIGS. 6 and 7 illustrate a battery assembly 99 that includes a battery array 78, a heat exchanger 25 and a tray 27. The battery array 78 is constructed of a plurality of array frames 54 that are connected together and house battery cells 56. Each array frame 54 includes a slot 94. Once connected together, the slots 94 of the array frames 54 align to establish a channel 29 (see FIG. 6) that extends through the battery array 78.

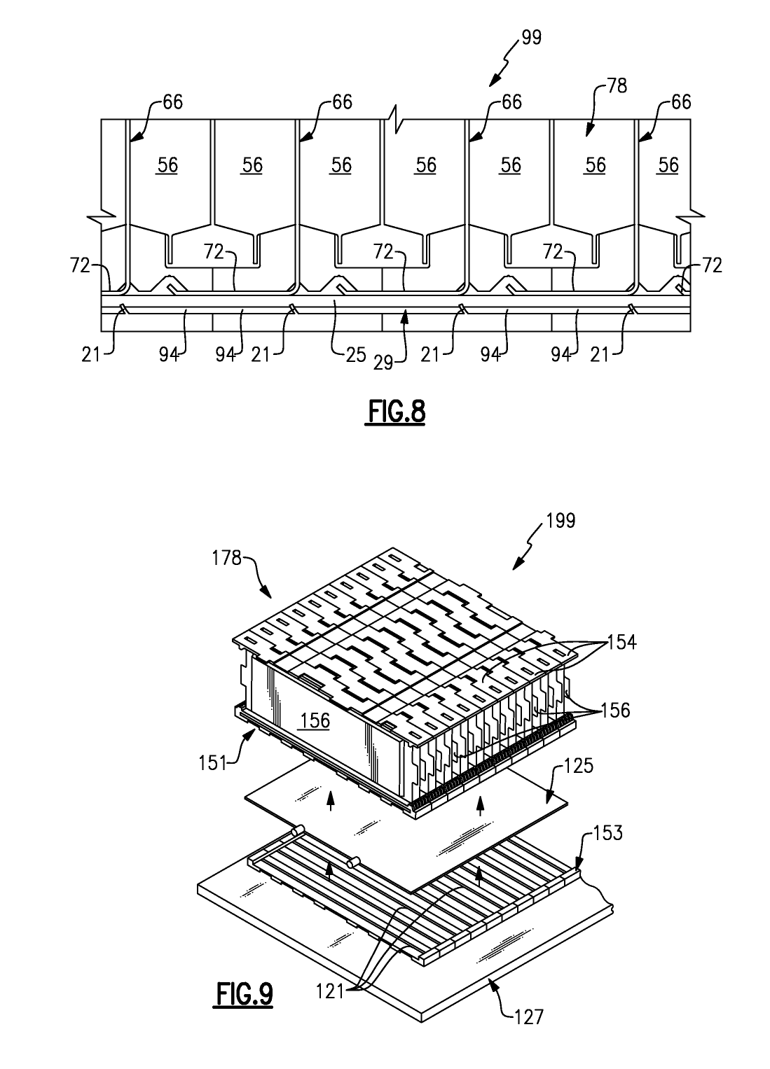

The heat exchanger 25 may be inserted into the channel 29 to connect it to the array frames 54, and thus, to the battery array 78. In this way, the heat exchanger 25 is substantially integrated with the battery array 78. The heat exchanger 25 functions to remove heat generated by the battery cells 56 during certain conditions, or alternatively to heat the battery cells 56 during other conditions. In one embodiment, the heat exchanger 25 is configured as a cold plate. However, other implementations are also contemplated. The spring features 21 bias the heat exchanger 25 against the leg 72 of each thermal fin 66 within the channel 29 (see FIG. 8). Therefore, in this embodiment, a thermal interface material (TIM) may not be necessary to achieve sufficient heat transfer.

Referring now primarily to FIG. 7, the battery array 78 may be fixedly secured to the tray 27. In one embodiment, the battery array 78 is secured to the tray using one or more fasteners 31 that are inserted through openings 33 of the array frames 54. Other mechanical attachments are also contemplated as within the scope of this disclosure.

In the assembled position shown in FIG. 7, the heat exchanger 25 is supported between the battery cells 56 and the tray 27. In one embodiment, the bottom wall 90 of the array frames 54 thermally isolates the heat exchanger 25 from the tray 27 so that heat from the battery cells 56 is not conducted through the tray 27.

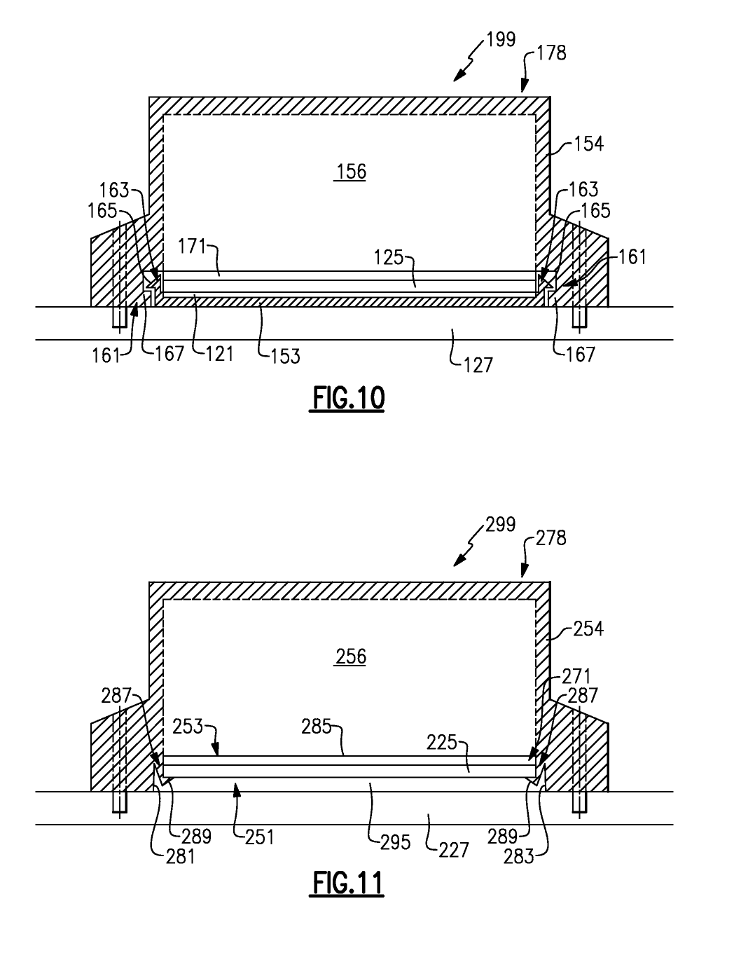

Another battery assembly 199 is illustrated in FIGS. 9 and 10. In this disclosure, like reference numbers designate like elements where appropriate and reference numerals with the addition of 100 or multiples thereof designate modified elements that are understood to incorporate the same features and benefits of the corresponding original elements. Like the battery assembly 99 discussed above, the exemplary battery assembly 199 includes a battery array 178, a heat exchanger 125 and a tray 127. The battery array 178 is constructed of a plurality of array frames 154 that are connected together and house battery cells 156. The array frames 154 of this embodiment include open bottoms 151 rather than slots. A lower cover 153 is connectable to the array frames 154 at the open bottoms 151 to position the heat exchanger 125 between the battery cells 156 and the lower cover 153.

In one embodiment, as best illustrated in FIG. 10, the array frames 154 include first retention arms 161 and the lower cover 153 includes second retention arms 163. The first and second retention arms 161, 163 engage one another to secure the lower cover 153 to the array frames 154 of the battery array 178. The array frames 154 and the lower cover 153 may each include two or more retention arms that are molded portions of these components. One of the first retention arms 161 and the second retention arms 163 may act as a male retention arm, while the other of the first retention arms 161 and the second retention arms 163 acts as female retention arm to secure the lower cover 153 to the array frames 154.

In another embodiment, extensions 165 of the second retention arms 163 overlap corresponding extensions 167 of the first retention arms 161 to secure the lower cover 153 to the array frames 154. The second retention arms 163 may flex inwardly and then flex outwardly to overlap the extensions 167 of the rigid first retention arms 161. Of course, an opposite configuration is also contemplated in which the first retention arms 161 are flexible and the second retention arms 163 are rigid.

Once the lower cover 153 is secured to the array frames 154, the heat exchanger 125 is considered “integrated” with the battery array 178. In one embodiment, the lower cover 153 thermally isolates the heat exchanger 125 from the tray 127 so that heat from the battery cells 156 is not conducted through the tray 127. In another non-limiting embodiment, the lower cover 153 includes spring features 121 that bias the heat exchanger 125 toward the battery cells 156, or optionally, toward a TIM 171 disposed between the battery cells 156 and the heat exchanger 125. The TIM 171 may be made from a material having a relatively high thermal conductivity and is configured to maintain thermal contact between the battery cells 156 and the heat exchanger 125 to increase the thermal conductivity between these neighboring components during a heat transfer event.

FIG. 11 illustrates yet another exemplary battery assembly 299. The battery assembly 299 of this embodiment includes a battery array 278, a heat exchanger 225 and a tray 227. The battery array 278 is constructed of one or more array frames 254 that are connected together and house battery cells 256. The array frames 254 of this embodiment include open bottoms 251 that establish a pocket 253 at a bottom portion 262 of the array frames 254.

In one non-limiting embodiment, the pockets 253 include a perimeter bounded by a first side wall 281, a second side wall 283 and a top wall 285 that extends between the first side wall 281 and the second side wall 283. One or more retention arms 287 for connecting the heat exchanger 225 to the battery array 278 may protrude into the pockets 253. The retention arms 287 may protrude into the pocket 253 from the side walls 281, 283, the top wall 285, or from a junction between the first side wall 281/second side wall 283 and the top wall 285. The retention arms 287 are flexible and include extensions 289 for receiving the heat exchanger 225. For example, the heat exchanger 225 may rest atop the extensions 289 to secure it to the battery array 278. A TIM 271 may be positioned between the battery cells 256 and the heat exchanger 225. In addition, an air gap 295, which is part of the pocket 253, may thermally isolate the heat exchanger 225 from the tray 227.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery assembly, comprising:
an array frame including a frame body and a slot formed through said frame body;
a heat exchanger received within said slot.

2. The assembly as recited in claim 1, wherein said frame body extends along a longitudinal axis and includes a top portion, a bottom portion and frame arms that extend between said top portion and said bottom portion.

3. The assembly as recited in claim 2, wherein said top portion includes a first side and a second side that each include an alternating pattern of rigid snap arms and flexible snaps arms.

4. The assembly as recited in claim 2, wherein said slot is formed in said bottom portion of said frame body.

5. The assembly as recited in claim 1, comprising a thermal fin extending within said frame body, wherein said thermal fin includes a body and a leg that extends to a position outside of said frame body.

6. The assembly as recited in claim 5, wherein said heat exchanger is biased against said leg of said thermal fin.

7. The assembly as recited in claim 1, wherein said frame body includes a bottom portion including a top wall and a bottom wall that extend between opposing ends, said slot extending horizontally between said opposing ends and vertically between said top wall and said bottom wall.

8. The assembly as recited in claim 7, comprising a spring feature that protrudes upwardly from said bottom wall.

9. The assembly as recited in claim 8, wherein said spring feature is angled relative to said bottom wall.

10. The assembly as recited in claim 8, wherein said spring feature is corrugated.

11. A battery assembly, comprising:
an array frame including at least one retention arm; and
a heat exchanger connected to said array frame by said at least one retention arm.

12. The assembly as recited in claim 11, wherein said array frame houses a battery cell, and comprising a thermal interface material between said battery cell and said heat exchanger.

13. The assembly as recited in claim 11, wherein said array frame includes an open bottom that establishes a pocket bound by side walls and a top wall, wherein said at least one retention arm protrudes from at least one of said side walls and said top wall.

14. The assembly as recited in claim 11, wherein said array frame is mounted to a tray.

15. The assembly as recited in claim 14, comprising an air gap between said heat exchanger and said tray.

16. A battery assembly, comprising:
a battery array including a plurality of array frames;
a lower cover connected to at least a portion of said plurality of array frames; and
a heat exchanger secured between said battery array and said lower cover.

17. The assembly as recited in claim 16, comprising a thermal interface material between said heat exchanger and said plurality of array frames.

18. The assembly as recited in claim 16, wherein one of said portion of said plurality of array frames and said lower cover includes a rigid retention arm and the other of said portion of said plurality of array frames and said lower cover includes a flexible retention arm that engages said rigid retention arm to secure said lower cover to said portion of said plurality of array frames.

19. The assembly as recited in claim 18, wherein said flexible retention arm includes an extension that overlaps a second extension of said rigid retention arm.

20. The assembly as recited in claim 16, wherein said battery array is mounted to a tray.
